(19) United States
(12) Patent Application Publication
(10) Pub. No.: US 2015/0049412 A1
(43) Pub. Date: Feb. 19, 2015

(54) MULTILAYER CERAMIC CAPACITOR, METHOD OF MANUFACTURING THE SAME, AND PRESSING PLATE FOR MULTILAYER CERAMIC CAPACITOR

(71) Applicant: SAMSUNG ELECTRO-MECHANICS CO., LTD., Suwon (KR)

(72) Inventors: Tae Hyeok KIM, Suwon (KR); Byoung Hwa LEE, Suwon (KR); Jin Man JUNG, Suwon (KR)

(73) Assignee: SAMSUNG ELECTRO-MECHANICS CO., LTD., Suwon (KR)

(21) Appl. No.: 14/135,273

(22) Filed: Dec. 19, 2013

(30) Foreign Application Priority Data
Aug. 14, 2013 (KR) 10-2013-0096735

(51) Int. Cl. H01G 4/30; H01G 4/12

(52) U.S. Cl. CPC H01G 4/30; H01G 4/12
USPC 361/301.4; 156/89.12; 156/580

(57) ABSTRACT

There is provided a multilayer ceramic capacitor, including: a ceramic body including a plurality of dielectric layers stacked therein; first and second internal electrodes alternately exposed to both end surfaces of the ceramic body, having each of the dielectric layers disposed therebetween; and first and second external electrodes formed on the end surfaces of the ceramic body and electrically connected to the first and second internal electrodes, respectively, wherein a difference in rigidity between upper and lower portions of the ceramic body is 4% or less.

### CROSS-REFERENCE TO RELATED APPLICATION

This application claims the benefit of Korean Patent Application No. 10-2013-0096735 filed on Aug. 14, 2013, with the Korean Intellectual Property Office, the disclosure of which is incorporated herein by reference.

### BACKGROUND

The present disclosure relates to a multilayer ceramic capacitor, a method of manufacturing the same, and a pressing plate for a multilayer ceramic capacitor.

A multilayer ceramic capacitor (MLCC), a multilayer chip electronic component, is a chip-type condenser that is mounted on printed circuit boards of various electronic products such as display devices including liquid crystal displays (LCDs) and plasma display panels (PDPs), computers, personal digital assistants (PDAs), cell phones, and the like, to allow electricity to be charged therein and discharged therefrom.

A multilayer ceramic capacitor (MLCC) is used in various types of electronic components since it is relatively small and can be easily mounted while implementing high capacitance.

Recently, as performance levels of smart devices such as smartphones and tablet PCs have increased, driving speeds of application processors (AP) responsible for operations have also increased accordingly.

As the driving speed of the AP has increased, current of a higher frequency needs to be rapidly supplied to the AP.

The above-mentioned multilayer ceramic capacitor serves to supply current to the AP. Therefore, in order to rapidly supply high-frequency current, it is necessary to reduce a distance to an AP by employing a multilayer ceramic capacitor having low equivalent series inductance (ESL) or by embedding a multilayer ceramic capacitor in a board.

However, the use of a multilayer ceramic capacitor having low ESL may cause other structural problems, and thus a multilayer ceramic capacitor embedded in a board has recently been developed.

In the process of manufacturing such an embedded multilayer ceramic capacitor, internal electrodes and dielectric layers are stacked, and subsidiary materials are placed on upper and lower surfaces of a multilayer body and pressed to form a ceramic body.

In the related art, a lower subsidiary material supporting the multilayer body is formed of a material having a certain degree of rigidity, while an upper subsidiary material pressing the multilayer body downwardly is formed of a soft material having a lower degree of rigidity.

In a case in which the upper subsidiary material is formed of a rigid material, the upper side of a ceramic body may be indented or portions of ends of the ceramic body may be delaminated.

In a case in which the upper subsidiary material is formed of a soft material, however, differences in shape and density between the upper and lower portions of the ceramic body may occur after pressing, due to differences in rigidity of upper and lower subsidiary materials. This causes edges on upper sides of the ceramic body to be bent downwardly, so-called warpage, thereby reducing product reliability.

Patent Document 1 discloses first and second pressing plates to press upper and lower surfaces of a multilayer body, but does not disclose a double-layer structure of an upper pressing plate including a first upper pressing plate formed of a soft material and a second upper pressing plate formed of a rigid material, as taught by the present disclosure for suppressing warpage.

### RELATED ART DOCUMENT

(Patent Document 1) Korean Patent Laid-Open Publication No. 2012-0055246

### SUMMARY

An aspect of the present disclosure may provide a multilayer ceramic capacitor of which both ends are prevented from being bent downwardly, i.e., warping, and from being indented, or portions of the ends thereof are prevented from being delaminated.

According to an aspect of the present disclosure, a multilayer ceramic capacitor may include: a ceramic body including a plurality of dielectric layers stacked therein; first and second internal electrodes alternately exposed to both end surfaces of the ceramic body, having each of the dielectric layers disposed therebetween; and first and second external electrodes formed on the end surfaces of the ceramic body and electrically connected to the first and second internal electrodes, respectively, wherein a difference in rigidity between upper and lower portions of the ceramic body may be 4% or less.

The ceramic body may have a thickness of 100 μm or less.

A difference between T1 and T2 may be 4 μm or less, where T1 denotes a maximum thickness of the ceramic body, and T2 denotes a minimum thickness of the ceramic body.

The multilayer ceramic capacitor may further include first and second plating layers covering the first and second external electrodes.

According to another aspect of the present disclosure, a method of manufacturing a multilayer ceramic capacitor may include: preparing a plurality of ceramic green sheets; forming first and second internal electrodes on the individual ceramic green sheets to be exposed in opposing directions by using a conductive paste; forming a multilayer body by stacking the plurality of ceramic green sheets having the first and second internal electrodes formed thereon and pressing upper and lower surfaces thereof with upper and lower pressing plates in a vertical direction; forming a ceramic body by sintering the multilayer body; and forming first and second external electrodes to be electrically connected to portions of the first and second internal electrodes exposed to both end surfaces of the ceramic body, wherein the upper pressing plate may include a first upper pressing plate formed of a soft material and disposed to be in contact with an upper surface of the multilayer body, and a second upper pressing plate formed of a rigid material and attached to the first upper pressing plate, and the lower pressing plate may be formed of a rigid material.

The forming of the multilayer body may include stacking and pressing the first and second internal electrodes and the plurality of ceramic green sheets such that a difference in rigidity between upper and lower portions of the multilayer body is set to be 4% or less.

The forming of the multilayer body may include stacking and pressing the first and second internal electrodes and the plurality of ceramic green sheets such that a thickness of the multilayer body is set to be 100 μM or less.

The forming of the multilayer body may include stacking and pressing the first and second internal electrodes and the plurality of ceramic green sheets such that a difference between T1 and T2 is set to be 4 μm or less, where T1 denotes a maximum thickness of the ceramic body, and T2 denotes a minimum thickness of the ceramic body.

The method may further include forming first and second plating players covering the first and second external electrodes, after the forming of the first and second external electrodes.

According to another aspect of the present disclosure, a pressing plate for a multilayer ceramic capacitor, the pressing plate being used in pressing a multilayer body in which first and second internal electrodes and ceramic green sheets are stacked, the pressing plate may include: a lower pressing plate formed of a rigid material and disposed to be in contact with a lower surface of the multilayer body; a first upper pressing plate formed of a soft material and disposed to be in contact with an upper surface of the multilayer body; and a second upper pressing plate formed of a rigid material and attached to the first upper pressing plate.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a multilayer ceramic capacitor according to an exemplary embodiment of the present disclosure;

FIG. 2 is a front view schematically illustrating a multilayer ceramic capacitor according to an exemplary embodiment of the present disclosure;

FIG. 3 is a cross-sectional view taken along line A-A′ of FIG. 1;

FIG. 4 is a cross-sectional view schematically illustrating the multilayer ceramic capacitor of FIG. 3 to which plating layers are added;

FIG. 5 is a cross-sectional view illustrating pressing upper and lower surfaces of a ceramic body in a method of manufacturing a multilayer ceramic capacitor according to an exemplary embodiment of the present disclosure; and

FIG. 6 is a cross-sectional view illustrating warpage of a ceramic body of a multilayer ceramic capacitor according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific exemplary embodiments set forth herein. Rather, these exemplary embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

In order to clearly describe exemplary embodiments of the present disclosure, directions of the ceramic body 110 will be defined as follows: L, W and T shown in the drawings refer to a length direction, a width direction, and a thickness direction, respectively. Here, the thickness direction may be the same as a direction in which dielectric layers are stacked.

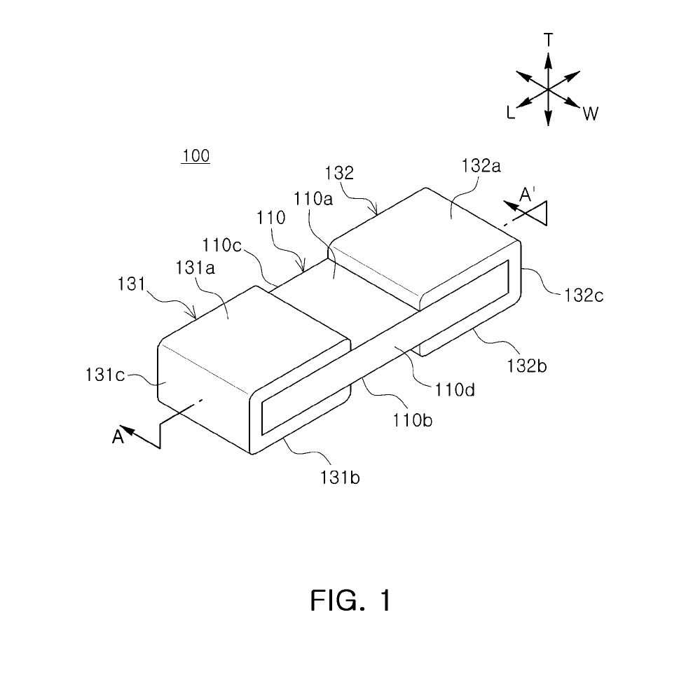

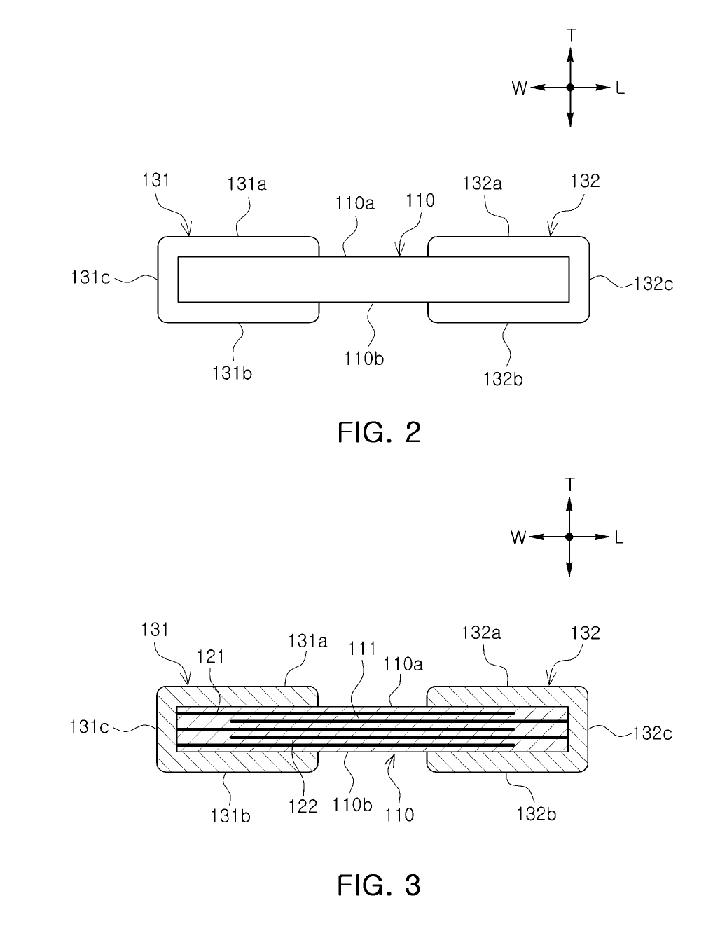

FIG. 1 is a perspective view schematically illustrating a multilayer ceramic capacitor according to an exemplary embodiment of the present disclosure; FIG. 2 is a front view schematically illustrating a multilayer ceramic capacitor according to an exemplary embodiment of the present disclosure; and FIG. 3 is a cross-sectional view taken along line A-A′ of FIG. 1.

Referring to FIGS. 1 to 3, a multilayer ceramic capacitor 100 according to an exemplary embodiment of the present disclosure includes a ceramic body 110, first and second internal electrodes 121 and 122, and first and second external electrodes 131 and 132.

The ceramic body 110 may be shaped like a hexahedron having first and second main surfaces 110a and 110b and first and second side surfaces 110c and 110d. The first and second main surfaces 110a and 110b may be extended in the length direction L and in the width direction W of the ceramic body 110. The first and second side surfaces 110c and 110d may be extended in the thickness direction T and in the length direction L of the ceramic body 110. Surfaces of the ceramic body 110 on which the first and second external electrodes 131 and 132 are formed may be referred to as first and second end surfaces.

The ceramic body 110 may be formed by stacking the dielectric layers 111 in the thickness direction T and then sintering them. The shape and dimensions of the ceramic body 110 and the number of dielectric layers 111 are not limited to those illustrated in the exemplary embodiment.

Table 1 below shows values of T1−T2 (occurrence of warpage) and reliability failures according to differences in rigidity of upper and lower portions of the ceramic body 110. T1 denotes a maximum thickness of the ceramic body 110, T2 denotes a minimum thickness of the ceramic body 110. When a difference between T1 and T2 is 4 μm or more, it is determined that warpage occurred. Further, reliability was evaluated in a manner such that two hundred multilayer ceramic capacitors 100 were mounted on respective printed circuit boards and the number of broken chips was determined.

TABLE 1

| | Difference in | | |
|---|---|---|---|
| Thickness | Rigidity between | | Reliability |
| of Ceramic | Upper and Lower Portions | T1 − T2 | Failure |
| Body (μm) | of Ceramic Body (%) | (μm) | (EA) |
| 80 | 2% | 0.8 | 0/200 |
| | 3% | 1.60 | 0/200 |
| | 4% | 1.90 | 0/200 |
| | 5% | 4.20 | 22/200 |
| | 6% | 5.20 | 42/200 |
| 100 | 2% | 0.70 | 0/200 |
| | 3% | 1.20 | 0/200 |
| | 4% | 1.80 | 0/200 |
| | 5% | 4.00 | 17/200 |
| | 6% | 4.80 | 31/200 |
| 150 | 2% | 0.5 | 0/200 |
| | 3% | 0.71 | 0/200 |
| | 4% | 0.82 | 0/200 |
| | 5% | 0.91 | 0/200 |
| | 6% | 1.20 | 0/200 |
| 200 | 2% | 0.31 | 0/200 |
| | 3% | 0.35 | 0/200 |
| | 4% | 0.39 | 0/200 |
| | 5% | 0.42 | 0/200 |
| | 6% | 0.50 | 0/200 |

As can be seen from Table 1, in the case of general multilayer ceramic capacitors having a thickness greater than 100 μm, i.e., ceramic bodies thereof having a thickness of 150 μm or 200 μm, T1−T2 was less than 4 μm, so that warpage did not occur regardless of differences in rigidity between the upper and lower portions of the ceramic body, and thus, defective products were not found in the reliability evaluation.

However, this exemplary embodiment is related to the embedded multilayered ceramic capacitor, and the thickness of the ceramic body 110 may be 100 μm or less.

In the case of existing embedded multilayer ceramic capacitors having a thickness of 100 μm or less, a difference in rigidity between the upper and lower portions of the ceramic body exceeds approximately 23% due to the reduced thickness, and thus, a warpage occurrence rate is approximately 38%. Accordingly, reliability failure also increases. However, in the process of manufacturing the multilayer ceramic capacitor according to the exemplary embodiment, a ceramic body is pressed using an upper pressing plate having a double-layer structure in which a first upper pressing plate is formed of a soft material and disposed to be in contact with the upper surface of a multilayer body, and a second upper pressing plate is formed of a rigid material and disposed to be in contact with the first upper pressing plate, and thus, although the thickness of the ceramic body is 100 μm or less, the value of T1−T2 is lower than that of an existing embedded multilayer ceramic capacitor, and no warpage occurs.

In particular, in the multilayer ceramic capacitor according to the exemplary embodiment, the difference in rigidity between the upper and lower portions of the ceramic body is 4% or less, so that no warpage occurs.

In particular, when the difference in rigidity between the upper and lower portions of the ceramic body 110 is 4% or less, the value of T1−T2 is less than 4 μm, more preferably less than 2 μm, so that no warpage occurs, and thus, defective products are not found in the reliability evaluation.

The plurality of dielectric layers 111 forming the ceramic body 110 are in a sintered state, so that boundaries between adjacent dielectric layers 111 are not readily apparent without the aid of a scanning electron microscope (SEM).

The ceramic body 110 may include an active region 110A contributing to creating capacitance of the capacitor, and upper and lower margin parts formed on and below the active region 110A. The upper and lower margin parts may prevent the first and second internal electrodes 121 and 122 from being damaged by physical or chemical stresses.

The thickness of the dielectric layers 111 may be adjusted according to a target capacitance of the multilayer ceramic capacitor 100. The dielectric layers 111 may include a ceramic powder having high dielectric permittivity, e.g., a BaTiO₃-based powder or a SrTiO₃-based powder. However, the present disclosure is not limited thereto.

The first and second internal electrodes 121 and 122, a pair of electrodes having opposite polarities, may be formed by printing a conductive paste including a conductive metal on the plurality of dielectric layers 111 at a predetermined thickness and be stacked to face each other with the dielectric layer interposed therebetween in the thickness direction T, while they are alternately exposed to the end surfaces of the ceramic body 110. The first and second internal electrodes 121 and 122 may be electrically insulated from each other by the dielectric layer 111 interposed therebetween.

The first and second internal electrodes 121 and 122 may be electrically connected to the first and second external electrodes 131 and 132 formed on the end surfaces of the ceramic body 110, through the portions thereof alternately exposed to the end surfaces of the ceramic body 110.

Therefore, when voltages are applied to the first and second external electrodes 131 and 132, charges may be accumulated between the first and second internal electrodes 121 and 122 facing each other. The capacitance of the multilayer ceramic capacitor 100 is proportional to an area of the active region 110A where the first and second internal electrodes 121 and 122 overlap one another.

The width of the first and second internal electrodes 121 and 122 may be determined depending on intended use, and may be, but is not limited to, 0.2 μm to 1.0 μm taking into account the size of the ceramic body 110.

The conductive metal contained in the conductive paste forming the first and second internal electrodes 121 and 122 may be, but is not limited to, nickel (Ni), copper (Cu), palladium (Pd) or an alloy thereof.

The method of printing the conductive paste may be, but is not limited to, a screen printing method or a gravure printing method.

The first and second external electrodes 131 and 132 may be formed on the end surfaces of the ceramic body 110, and they may also cover portions of the upper and lower surfaces of the ceramic body 110.

The first and second external electrodes 131 and 132 may include bands 131a, 131b, 132a and 132b covering portions of the first and second main surfaces 110a and 110b of the ceramic body 110, and head portions 131c and 132c covering the end surfaces of the ceramic body 110 in the length direction thereof.

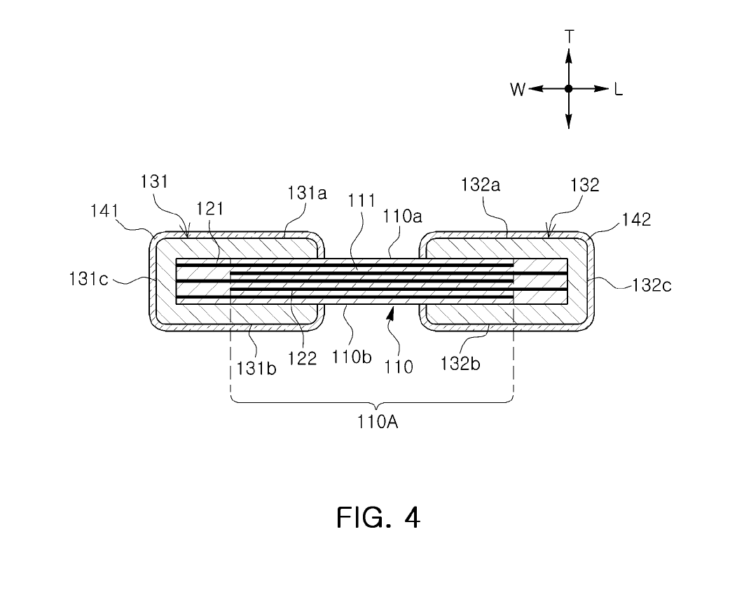

Referring to FIG. 4, first and second plating layers 141 and 142 may be further formed to cover the first and second external electrodes 131 and 132 on the end surfaces of the ceramic body 110.

The first and second plating layers 141 and 142 may further increase an effect of preventing cracks from occurring in the ceramic body 110, due to contraction or tensile stress during the plating process.

Hereinafter, a relationship between the maximum and minimum thicknesses of a ceramic body included in a multilayer ceramic capacitor according to an exemplary embodiment of the present disclosure and warpage occurrence will be described.

### Experimental Example

Multilayer ceramic capacitors according to Inventive Examples and Comparative Examples were manufactured as described below.

A slurry containing a powder such as a barium titanate (BaTiO₃) powder was applied to carrier films and dried to prepare a plurality of ceramic green sheets having a predetermined thickness.

Then, a conductive paste is applied to the ceramic green sheets using a screen and the like, to form the first and second internal electrodes 121 and 122 alternately exposed to opposing ends of the ceramic green sheets.

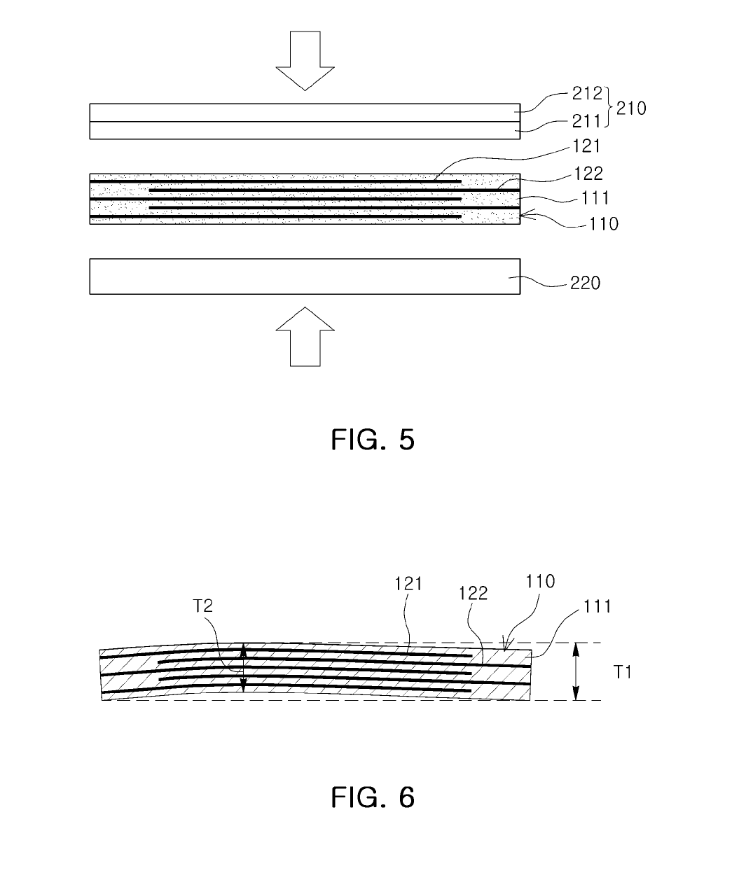

Thereafter, as shown in FIG. 5, the ceramic green sheets were stacked on one another in the thickness direction T, and, upper and lower pressing plates 210 and 220 were used to press upper and lower surfaces of the stacked ceramic green sheets, respectively, while the ceramic green sheets were isostatically pressed under a pressure of 1,000 kgf/cm² at a temperature of 85° C., and thus, a multilayer body was manufactured.

The upper pressing plate 210 may include a first upper pressing plate 211 formed of a soft material and disposed to contact an upper surface of the multilayer body, and a second upper pressing plate 212 formed of a rigid material and attached to the first upper pressing plate 211.

Since the first upper pressing plate 211 is formed of a soft material, it may completely contact the upper surface of the multilayer body despite step portions between the margin parts in which only the ceramic sheets exist and the active region in which the internal electrodes are formed on the ceramic sheets, whereby the ends of the multilayer body may be prevented from being indented or portions of the ends of the multilayer body may be prevented from being delaminated.

In addition, since the second upper pressing plate 212 disposed on the first upper pressing plate 211 is formed of a rigid material, it may evenly apply pressure to the upper portion of the multilayer body, whereby the ends of the multilayer body may be prevented from being bent downwards, i.e., warping.

Further, the lower pressing plate 220 may be disposed on the lower surface of the multilayer body and may be formed of a rigid material.

Further, this exemplary embodiment is related to the embedded multilayered ceramic capacitor, and the thickness of the ceramic body 110 may be 100 μm or less.

Then, the pressed multilayer body was cut into individual chips, and the chips was subjected to de-binding in air atmosphere at approximately 230° C. for approximately sixty hours.

Then, the chips were sintered at approximately 1,200° C. in a reducing atmosphere with oxygen partial pressure between 10⁻¹¹ atm and 10⁻¹⁰ atm, lower than an Ni/NiO equilibrium oxygen partial pressure, in order for the first and second internal electrodes 121 and 122 not to be oxidized.

The length×width (L×W) of the ceramic body 110 after sintering was approximately 0.950 mm×0.500 mm (L×w, so-called 1005 size). Here, the fabrication tolerance was ±0.1 mm or less in length×width (L×W).

Then, the first and second external electrodes 131 and 132 were formed on the end surfaces of the ceramic body 110.

Optionally, a plating process was performed to form the first and second plating layers 141 and 142 covering the first and second external electrodes 131 and 132 formed on the end surfaces of the ceramic body 110.

The manufactured multilayer ceramic capacitors were tested to measure warpage occurrence.

TABLE 2

| Sample | T1(um) | T2(um) | T1 − T2(um) |
|---|---|---|---|
| Average | 69.95 | 68.37 | 1.58 |
| 1 | 71.24 | 69.17 | 2.07 |
| 2 | 76.35 | 69.17 | 7.18 |
| 3 | 69.97 | 69.16 | 0.81 |
| 4 | 68.33 | 68.23 | 0.1 |
| 5 | 70.07 | 68.22 | 1.85 |
| 6 | 69.13 | 68.22 | 0.91 |
| 7 | 67.75 | 66.36 | 1.39 |
| 8 | 70.54 | 68.25 | 2.29 |
| 9 | 69.24 | 68.25 | 0.99 |
| 10 | 67.76 | 67.35 | 0.41 |
| 11 | 69.63 | 68.23 | 1.4 |
| 12 | 68.25 | 67.29 | 0.96 |
| 13 | 72.43 | 68.22 | 4.21 |
| 14 | 72.43 | 70.1 | 2.33 |
| 15 | 70.09 | 69.17 | 0.92 |
| 16 | 71.96 | 70.09 | 1.87 |
| 17 | 67.77 | 67.29 | 0.48 |
| 18 | 69.15 | 68.22 | 0.93 |
| 19 | 70.1 | 70.06 | 0.04 |
| 20 | 66.85 | 66.36 | 0.49 |

Data in Table 2 indicate differences between the maximum and minimum thicknesses of the ceramic bodies in embedded multilayer ceramic capacitors formed by pressing the ceramic bodies using general upper and lower pressing plates.

Here, it was determined that warpage occurred in the embedded multilayer ceramic capacitor when a difference between T2 and T1 exceeded 4 μm, where T1 denotes the maximum thickness of the ceramic body 110 and T2 denotes the minimum thickness of the ceramic body 110. Warpage occurred in two samples, i.e., sample Nos. 2 and 13, among total 20 samples.

TABLE 3

| Sample | T1(um) | T2(um) | T1 − T2(um) |
|---|---|---|---|
| Average | 61.44 | 60.84 | 0.60 |
| 1 | 61.09 | 60.15 | 0.94 |
| 2 | 62.6 | 62.21 | 0.39 |
| 3 | 60.71 | 60.1 | 0.61 |
| 4 | 60.64 | 59.17 | 1.47 |
| 5 | 61.61 | 60.71 | 0.9 |
| 6 | 63.4 | 62.59 | 0.81 |
| 7 | 60.64 | 59.6 | 1.04 |
| 8 | 62.03 | 61.61 | 0.42 |
| 9 | 61.79 | 61.68 | 0.11 |
| 10 | 60.86 | 60.64 | 0.22 |
| 11 | 63.89 | 63.58 | 0.31 |
| 12 | 59.1 | 58.17 | 0.93 |
| 13 | 61.97 | 61.61 | 0.36 |
| 14 | 60.64 | 60.64 | 0 |
| 15 | 60.14 | 59.66 | 0.48 |
| 16 | 60.59 | 59.69 | 0.9 |
| 17 | 61.11 | 59.67 | 1.44 |
| 18 | 63.6 | 63.14 | 0.46 |
| 19 | 60.64 | 60.6 | 0.04 |
| 20 | 61.81 | 61.61 | 0.2 |

Data in Table 3 indicate differences between the maximum and minimum thicknesses of the ceramic bodies in embedded multilayer ceramic capacitors formed by pressing the ceramic bodies using the upper and lower pressing plates according to the exemplary embodiment.

As can be seen from Table 3, there is no sample having a value of T1-T2 greater than 4 μm, preferably greater than 2 μm, where T1 denotes the maximum thickness of the ceramic body and T2 denotes the minimum thickness of the ceramic body, and thus no warpage occurred.

As set forth above, in a multilayer ceramic capacitor according to exemplary embodiments of the present disclosure, a difference in rigidity between upper and lower portions of a ceramic body is 4% or less, whereby both ends of the multilayer ceramic capacitor may be prevented from being bent downwardly, i.e., warping and from being indented, or portions of the ends thereof may be prevented from being delaminated.

While exemplary embodiments have been shown and described above, it will be apparent to those skilled in the art that modifications and variations could be made without departing from the spirit and scope of the present disclosure as defined by the appended claims.

What is claimed is:

1. A multilayer ceramic capacitor, comprising:
a ceramic body including a plurality of dielectric layers stacked therein;
first and second internal electrodes alternately exposed to both end surfaces of the ceramic body, having each of the dielectric layers disposed therebetween; and
first and second external electrodes formed on the end surfaces of the ceramic body and electrically connected to the first and second internal electrodes, respectively,
wherein a difference in rigidity between upper and lower portions of the ceramic body is 4% or less.

2. The multilayer ceramic capacitor of claim 1, wherein the ceramic body has a thickness of 100 μm or less.

3. The multilayer ceramic capacitor of claim 1, wherein a difference between T1 and T2 is 4 μm or less, where T1 denotes a maximum thickness of the ceramic body, and T2 denotes a minimum thickness of the ceramic body.

4. The multilayer ceramic capacitor of claim 1, further comprising first and second plating layers covering the first and second external electrodes.

5. A method of manufacturing a multilayer ceramic capacitor, the method comprising:
preparing a plurality of ceramic green sheets;
forming first and second internal electrodes on the individual ceramic green sheets to be exposed in opposing directions by using a conductive paste;
forming a multilayer body by stacking the plurality of ceramic green sheets having the first and second internal electrodes formed thereon and pressing upper and lower surfaces thereof with upper and lower pressing plates in a vertical direction;
forming a ceramic body by sintering the multilayer body; and
forming first and second external electrodes to be electrically connected to portions of the first and second internal electrodes exposed to both end surfaces of the ceramic body,
wherein the upper pressing plate includes a first upper pressing plate formed of a soft material and disposed to be in contact with an upper surface of the multilayer body, and a second upper pressing plate formed of a rigid material and attached to the first upper pressing plate, and
the lower pressing plate is formed of a rigid material.

6. The method of claim 5, wherein the forming of the multilayer body includes stacking and pressing the first and second internal electrodes and the plurality of ceramic green sheets such that a difference in rigidity between upper and lower portions of the multilayer body is set to be 4% or less.

7. The method of claim 5, wherein the forming of the multilayer body includes stacking and pressing the first and second internal electrodes and the plurality of ceramic green sheets such that a thickness of the multilayer body is set to be 100 μm or less.

8. The method of claim 5, wherein the forming of the multilayer body includes stacking and pressing the first and second internal electrodes and the plurality of ceramic green sheets such that a difference between T1 and T2 is set to be 4 μm or less, where T1 denotes a maximum thickness of the ceramic body, and T2 denotes a minimum thickness of the ceramic body.

9. The method of claim 5, further comprising forming first and second plating players covering the first and second external electrodes, after the forming of the first and second external electrodes.

10. A pressing plate for a multilayer ceramic capacitor, the pressing plate being used in pressing a multilayer body in which first and second internal electrodes and ceramic green sheets are stacked, the pressing plate comprising:
a lower pressing plate formed of a rigid material and disposed to be in contact with a lower surface of the multilayer body;
a first upper pressing plate formed of a soft material and disposed to be in contact with an upper surface of the multilayer body; and
a second upper pressing plate formed of a rigid material and attached to the first upper pressing plate.
